(19) United States
(12) Patent Application Publication
(10) Pub. No.: US 2025/0214276 A1
(43) Pub. Date: Jul. 3, 2025

(54) In-Process Drying for Oil Based Timber Treatment

(71) Applicant: ARXADA AG, Visp (CH)

(72) Inventors: Jamie Nuttall, Leeds, West Yorkshire (GB); Michael Bacon, Castleford, West Yorkshire (GB); Andrew Hughes, Visp (CH); Hannah Griffiths, Visp (CH); Stephen Uphill, Castleford (GB)

(21) Appl. No.: 18/851,229

(22) PCT Filed: Mar. 31, 2023
(86) PCT No.: PCT/IB2023/053280

§ 371 Date: Sep. 26, 2024

Related U.S. Application Data
(60) Provisional application No. 63/427,139, filed on Nov. 22, 2022.

(51) Int. Cl. B27K 3/02; B27K 3/22

(52) U.S. Cl. CPC B27K 3/0278; B27K 3/0214; B27K 3/22

(57) ABSTRACT

In general, the present disclosure is directed to a method for treating a wood product. The method disclosed herein includes: i) injecting an oil-based preservative into a treatment chamber with the wood product; ii) pressurizing the treatment chamber with the wood product and the oil-based preservative in order to impregnate the wood product with the oil-based preservative; iii) releasing the pressure of the treatment chamber to atmospheric pressure; iv) performing an intermediate drying phase; v) after performing the intermediate drying phase, draining the oil-based preservative from the treatment chamber; and vi) applying a vacuum within the treatment chamber in order to remove excess preservative from surface of the impregnated wood product.

### RELATED APPLICATIONS

The present application is based on and claims priority to U.S. Provisional Application Ser. No. 63/325,857 filed on Mar. 31, 2022 and U.S. Provisional Application Ser. No. 63/427,139 filed on Nov. 22, 2022, and, which are incorporated herein by reference.

### BACKGROUND

Wood and wood-based products used for heavy-duty applications (such as, but not limited to, poles, sleepers, and agricultural posts) usually contain 20-40% moisture prior to preservative treatment, which can migrate into the treatment solution during treatment, and, if not managed correctly, can lead to, amongst other things, destabilization of the preservative, excessive corrosion, and oxidation of the oil, all of which result in solids formation (seen as sludge or ‘varnish’) in the treatment solution.

Typically, oil-based wood preservatives, such as Creosote, have been used at temperatures above 100° C. At such temperatures, the treated timber is removed from the treatment autoclave relatively ‘touch-dry’ with minimal free liquid on the surface. More modern Cu-Organic type oil-based wood preservative systems, such as Tanasote S40®, cannot be used at such high temperatures due to chemical instability. Thus, lower application temperatures are required for the modern Cu-organic type oil-based wood preservative systems, which can result in a ‘sweaty’ or ‘sticky’ surface immediately after treatment under normal working conditions. Currently, timber must be stored on-site at the treatment facility, sometimes for periods of months, before the surface is touch dry. Alternatively, with systems such as Creosote, timber is retreated in a drying step to remove the excess surface liquid. In certain jurisdictions, this drying technique is not regularly allowed. In view of the above, a need exists for improved compositions and methods to overcome such surface appearance, which results in a touch-dry surface immediately after treatment.

### SUMMARY

In general, the present disclosure is directed to a method for treating a wood product. The method disclosed herein includes i) injecting an oil-based preservative into a treatment chamber with the wood product; ii) pressurizing the treatment chamber with the wood product and the oil-based preservative in order to impregnate the wood product with the oil-based preservative; iii) releasing the pressure of the treatment chamber to atmospheric pressure; iv) performing an intermediate drying phase to improve surface appearance and reduce free-oil on the surface of timber; v) after performing the intermediate ‘drying’ phase, draining the oil-based preservative from the treatment chamber; and vi) applying a vacuum within the treatment chamber in order to remove excess preservative from a surface of the impregnated wood product.

In one embodiment, from about 5% to about 30% of the oil-based preservative is drained from the treatment chamber during the intermediate drying phase.

In one embodiment, the wood product comprises one or more of a utility pole, a fence post, and a railway tie.

In one embodiment, the wood product comprises a product formed from one or more of pine, spruce, cedar, fir, hemlock, oak, maple, cherry, eucalyptus, poplar, beech, and aspen.

In one embodiment, the temperature of the oil-based preservative is no less than forty degrees Celsius when the wood product is impregnated with the oil-based preservative.

In one embodiment, the temperature of the oil-based preservative is about sixty degrees Celsius when the wood product is impregnated with the oil-based preservative.

In one embodiment, a vacuum of no greater than a half bar is used to during the ‘drying’ phase to remove excess preservative from the surface of the impregnated wood product.

In one embodiment, the oil-based preservative temperature is increased by up to about twenty degrees Celsius (20° C.) during the ‘drying’ phase compared to the temperature during the pressurizing step.

In one embodiment, the treatment chamber is pressurized for no less than five minutes and no greater than three hundred minutes to impregnate the wood product with the oil-based preservative.

In one embodiment, after the oil-based preservative has been drained from the treatment chamber, the vacuum is applied within treatment chamber for no less than thirty minutes to remove excess preservative from the surface of the impregnated wood product.

In one embodiment, removing the wood product impregnated with the oil-based preservative from the treatment chamber, a temperature of wood product impregnated with the oil-based preservative from the treatment chamber being no greater than sixty degrees Celsius when the wood product impregnated with the oil-based preservative is removed from the treatment chamber.

In one embodiment, the oil-based preservative comprises copper as the only biocide.

In one embodiment, the oil-based preservative comprises copper and at least one organic co-biocide.

In one embodiment, the copper is present within the oil-based preservative at no less than about 0.1% by weight of the oil-based preservative and no greater than about 10% by weight of the oil-based preservative.

In one embodiment, the at least one organic co-biocide agent is present at no less than about 0.01% by weight of the oil-based preservative and no greater than about 10% by weight of the oil-based preservative.

In one embodiment, the at least one organic co-biocide comprises one or more of an isothiazolone, a pyrethroid, a neonicotenoid, a halogenated carbamate, a quaternary ammonium salt, succinate dehydrogenase inhibitor (SDHI), and/or an azole.

In one embodiment, the impregnated wood product is incubated with the oil-based preservative for no more than one-hundred eighty minutes during the intermediate drying phase.

In one embodiment, the impregnated wood product is incubated with the oil-based preservative for no more than sixty minutes during the intermediate drying phase.

In one embodiment, the present disclosure provides a wood product treated with an oil-based preservative in a treatment chamber.

Each of the example aspects recited above may be combined with one or more of the other example aspects recited above in certain embodiments. For instance, all of the example aspects recited above may be combined with one another in some embodiments. As another example, any combination of two, three, four, five, or more of the twenty example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features and aspects, embodiments and advantages of the present invention will become better understood with reference to the following description and appended claims.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a Rueping Cycle without a drying phase.

FIG. 2 illustrates a Rueping Cycle with a drying phase.

### DETAILED DESCRIPTION

Reference will now be made in detail to example embodiments of the disclosure. It is to be understood by one of ordinary skill in the art that the present disclosure is a description of exemplary embodiments only and is not intended as limiting the broader aspects of the present disclosure.

The present disclosure is generally directed to a method for treating a wood product. According to the present disclosure, the method disclosed herein comprises i) injecting an oil-based preservative into a treatment chamber with the wood product; ii) pressurizing the treatment chamber containing the wood product and the oil-based preservative in order to impregnate the wood product with the oil-based preservative; iii) releasing the pressure of the treatment chamber to atmospheric pressure; iv) partially draining the oil-based product from the treatment chamber, and performing an intermediate drying phase; v) after performing the intermediate drying phase, draining the oil-based preservative from the treatment chamber; and vi) applying a vacuum within the treatment chamber in order to remove excess preservative from surface of the impregnated wood product. In one example embodiment, a temperature of the oil-based preservative is no greater than 90° C. when the wood product is impregnated with the oil-based preservative.

According to the present disclosure, the wood product is treated in a treatment chamber. The treatment chamber may be any suitable chamber for the purpose of treating a wood product. For example, the treatment chamber comprising a wood product may be a stainless steel pressure cylinder for horizontal loading, or a stainless steel industrial chamber for top-loading, and the like. In another embodiment, the treatment chamber may be a carbon steel pressure cylinder. Regardless of the particular treatment vessel utilized, the treatment vessel will be used for the treatment of wood products alone or in combination with an oil-based preservative.

In one example embodiment, methods disclosed herein include injecting a preservative into a treatment chamber with the wood product. The preservative may be an oil-based preservative. According to the present disclosure, the oil-based preservative may comprise one or more biocidal agents. For instance, the oil-based preservative may comprise copper (Cu) and at least one co-biocidal agent. In one example embodiment, copper is present in the oil-based preservative from about 0.01% by weight to about 10% by weight, such as from about 0.5% by weight to about 7.5% by weight, such as from about 1.5% by weight to about 5% by weight, or any range therebetween.

According to the present disclosure, the at least one co-biocide agent may be an organic co-biocide agent including, but not limited to, one or more of an isothiazolinone, a pyrethroid, a neonicotenoid, a halogenated carbamate, a quaternary ammonium salt, a succinate dehydrogenase inhibitor (SDHI), and/or an azole.

In one example embodiment, the organic co-biocidal agent may comprise an isothiazolone. For instance, the isothiazolinone may include, but is not limited to, 1,2-benzisothiazolin-3-one (“BIT”), N-(n-butyl)-1,2-benzisothiazolin-3-one, 4,5-dichloro-2-n-octyl-4-isothiazolin-3-one (“DCOIT”), 2-methyl-4-isothiazolin-3-one, 5-chloro-2-methyl-4-isothiazolin-3-one, 2-methyl-4-isothiazolin-3-one, 5-chloro-2-methyl-2H-isothiazol-3-one/2-methyl-2H-isothiazol-3-one (“CMIT/MIT”), or a combination thereof.

In one example embodiment, the organic co-biocidal agent may comprise a pyrethroid. For instance, the pyrethroid may include, but is not limited to, example acrinathrin, allethrin, bifenthrin ((2-methyl [1,1′-biphenyl]-3-yl)methyl (1R,3R)-rel-3-[(1Z)-2-chloro-3,3,3-trifluoro-1-propen-1-yl]-2,2-dimethylcyclopropanecarboxylate), chloroprallethrin, cycloprothrin, cyfluthrin, beta-cyfluthrin, cyhalothrin, lambda-cyhalothrin, gamma-cyhalothrin, cypermethrin (cyano (3-phenoxyphenyl)methyl 3-(2,2-dichloroethenyl)-2,2-dimethylcyclopropanecarboxylate), alpha-cypermethrin, beta-cypermethrin, theta-cypermethrin, zeta-cypermethrin, cyphenothrin, deltamethrin ((S)-cyano(3-phenoxyphenyl)methyl (1R,3R)-3-(2,2-dibromoethenyl)-2,2-dimethylcyclopropanecarboxylate), dimefluthrin, esfenvalerate, etofenprox ((1-[[2-(4-ethoxyphenyl)-2-methylpropoxy]methyl]-3-phenoxybenzene), fenpropathrin, fenvalerate, esfenvalerate, flucythrinate, flumethrin, fluvalinate, tau-fluvalinate, halfenprox, imiprothrin, kadethrin, metofluthrin, permethrin ((3-phenoxyphenyl)methyl 3-(2,2-dichloroethenyl)-2,2-dimethylcyclopropanecarboxylate), phenothrin, prallethrin, profluthrin, protrifenbute, pyrethrins I and II, resmethrin, silafluofen, tefluthrin, tetramethrin, tralomethrin, transfluthrin, valerate, and enantiomers thereof. In another example embodiment, the pyrethroid may be bifenthrin, cypermethrin, deltamethrin, etofenprox and permethrin, or a combination thereof.

In one example embodiment, the organic co-biocidal agent may comprise a neonicotenoid. For instance, the neonicotinoid may include, but is not limited to, acetamiprid ((1E)-N-[(6-chloro-3-pyridinyl)methyl]-N′-cyano-N-methylethanimidamide), clothianidin ((E)-1-[(2-chlorothiazol-5-yl)methyl]-3-methyl-2-nitroguanidine), dinotefuran (N-methyl-N′-nitro-N″-[(tetrahydro-3-furanyl)methyl]guanidine), imidacloprid ((2E)-1-[(6-chloro-3-pyridinyl)methyl]-N-nitro-2-imidazolidinimin), imidaclothiz, nitenpyram, nithiazine, paichongding, thiacloprid ((Z)-[3-[(6-chloro-3-pyridinyl)methyl]-2-thiazolidinylidene]cyanamide and thiamethoxam (3-[(2-chloro-5-thiazolyl)methyl]tetrahydro-5-methyl-N-nitro-4H-1,3,5-oxadiazin-4-imine). In one example embodiment, the neonicotinoid may be acetamiprid, clothianidin, dinotefuran, imidacloprid, thiacloprid and thiamethoxam, or a combination thereof.

In one example embodiment, the organic co-biocidal agent may comprise a halogenated carbamate. For instance, the halogenated carbamate may include, but is not limited to, 3-iodo-2-propynyl butyl carbamate (IPBC), 3-iodo-2-propynyl hexyl carbamate (IPHC), 3-iodo-2-propynyl cyclohexyl carbamate (IPCC), 3-iodo-2-propynyl phenyl carbamate (IPPhC), 3-iodo-2-propynyl benzyl carbamate (IP Benzyl C), 3-iodo-2-propynyl propyl carbamate (IPPC), 4-iodo-3-butynyl propyl carbamate (IBPC), 3-iodo-2-propynyl-4-chloro phenyl carbamate (IPCI PhC), 3-iodo-2-propynyl-4-chloro butyl carbamate (IPCI BC) and mixtures thereof. In one example embodiment, the halogenated carbamate may be 3-iodo-2-propynyl butyl carbamate (IPBC).

In one example embodiment, the organic co-biocidal agent may comprise an SDHI. For instance, the SDHI may include, but is not limited to, flutolanil, isofetamid, flupyram, fluxapyroxad, penthiopyrad, boscalid, fenfuram, caboxin, thifluzamide, benzovindiflupyr, bixafen, furametpyr, isopyrazam, penflufen, penthiopyrad, sedaxane, and mixtures thereof.

In one example embodiment, the organic co-biocidal agent may comprise a quaternary ammonium salt (quat). For instance, the quat might include, but is not limited to, didecyldimethylammonium chloride, didecyldimethylammonium carbonate, dimethylbenzyl ammonium chloride, and didecylmethylpoly(oxyethyl) ammonium proprionate, and mixtures thereof.

In one example embodiment, the organic co-biocidal agent may comprise an azole. For instance, the azole may include, but is not limited to, clotrimazole, imazalil, oxpoconazole, prochloraz, pefurazoate, triflumizole, triforine, buthiobate, pyrifenox, fenarimol, nuarimol, triarimol, azaconazole, bitertanol, bromuconazole, cyproconazole (α-(4-chlorophenyl)-α-(1-cyclopropylethyl)-1H-1,2,4-triazole-1-ethanol), diclobutrazole, difenoconazole, diniconazole, diniconazole-M, epoxiconazole (rel-1-[[(2R,3S)-3-(2-chlorophenyl)-2-(4-fluorophenyl)-2-oxiranyl]methyl]-1H-1,2,4-triazole), etaconazole, fenbuconazole, fluquinconazole, flusilazole, flutriafol, (α-butyl-α-(2,4-dichlorophenyl)-1H-1,2,4-triazole-1-ethanol), imibenconazole, ipconazole, ipfentrifluconazole, mefentrifluconazole, metconazole, myclobutanil, penconazole (1-[2-(2,4-dichlorophenyl) pentyl]-1H-1,2,4-triazole), propiconazole (1-[[2-(2,4-dichlorophenyl)-4-propyl-1,3-dioxolan-2-yl]methyl]-1H-1,2,4-triazole), prothioconazole, quinconazole, simeconazole, tebuconazole (α-[2-(4-chlorophenyl)ethyl]-α-(1,1-dimethylethyl)-1H-1,2,4-triazole-1-ethanol), tetraconazole, triadimefon (1-(4-chlorophenoxy)-3,3-dimethyl-1-(1H-1,2,4-triazol-1-yl)-2-butanone), triadimenol (β-(4-chlorophenoxy)-α-(1,1-dimethylethyl)-1H-1,2,4-triazole-1-ethanol), triticonazole and uniconazole. In one example embodiment, the azole may be cyproconazole, epoxiconazole, penconazole, propiconazole, tebuconazole, triadimefon, triadimenol, or a combination thereof.

According to the present disclosure, the one or more biocidal agent(s) may have a mean particle size of from about 0.01 μm to about 25 μm, such as from about 0.1 μm to about 10 μm, such as from about 0.3 μm to about 8 μm, or any range therebetween.

The at least one biocidal agent may be present at no less than about 0.01% by weight of the oil-based preservative and no greater than about 10% by weight of the oil-based preservative, such as from about 0.05% by weight to about 7.5% by weight, such as from about 0.5% by weight to about 5% by weight, such as about 1% by weight to about 3.5% by weight, or any range therebetween.

According to the present disclosure, the ratio of Cu (wt %) to co-biocide agent (wt %) in the oil-based preservative is from about 100:1 to about 1:100, such as from about 50:1 to about 1:1, such as from about 20:1 to about 1:1, or any range therebetween.

In accordance with the present disclosure, oil-based preservative is present in the treatment chamber at a temperature of from about 40° C. to about 110° C., such as from about 45° C. to about 90° C., such as from about 50° C. to about 75° C., such as from about 55° C. to about 65° C., or any range therebetween. Advantageously, the wood product may be treated with the oil-based preservative at a temperature of less than about 90° C., such as less than about 85° C., such as less than about 80° C., such as less than about 75° C., such as less than about 70° C., such as less than about 65° C., such as less than about 60° C., such as less than about 55° C., such as less than about 50° C., such as less than about 45° C.

According to the present disclosure, methods disclosed herein include impregnating the wood product with the oil-based preservative. Standard vacuum and/or pressure methods may be used to impregnate the wood. The standard processes are defined as described in New Zealand Timber Authority Specifications 1986, P2 Rueping (Empty Cell Process), P4 the Bethell Process, P5 the Lowry Process, and P9 the Alternating Pressure Method. In one example embodiment, the treatment chamber is pressurized with the wood product and the oil-based preservative in order to impregnate the wood product with the oil-based preservative. Immersing the wood product in the pressurized treatment chamber containing an oil-based preservative results in the oil-based preservative being homogenously impregnated into the surface of the wood product rather than merely applied onto the surface or penetrating only partially or inhomogenously into the wood product. The pressure applied to the treatment chamber in order to penetrate the wood product with an oil-based preservative may be from about 0.5 bar to about 12 bar, such as about 2 bar, such as about 3 bar, such as about 4 bar, such as about 5 bar, such as about 6 bar, such as about 7 bar, such as about 8 bar, such as about 9 bar, such as 10 bar, such as 11 bar. It is understood that the exact pressure value may depend on the wood product size and can be readily adapted by a skilled artisan. According to the present disclosure, the treatment chamber is pressurized for no less than about 5 minutes to impregnate the wood product with the oil-based preservative, such as no less than about 30 minutes, such as no less than about 60 minutes, such as no less than about 120 minutes, such as no less than about 180 minutes, such as no less than about 240 minutes. In one example embodiment, the treatment chamber is pressurized for no greater than 300 minutes to impregnate the wood product with the oil-based preservative, such as no greater than about 200 minutes, such as no greater than about 150 minutes, such as no greater than about 100 minutes, such as no greater than about 60 minutes.

In one example embodiment, the temperature of the oil-based preservative is no greater than about 110° C. when the wood product is impregnated with the oil-based preservative, such as no greater than about 90° C., such as no greater than about 85° C., such as no greater than about 80° C., such as no greater than about 75° C., such as no greater than about 70° C., such as no greater than about 65° C., such as no greater than about 60° C., such as no greater than about 55° C., such as no greater than about 50° C., such as no greater than about 45° C. In one example embodiment, the temperature of the oil-based preservative is greater than about 40° C. when the wood product is impregnated with the oil-based preservative, such as greater than about 50° C., such as greater than about 60° C., such as greater than about 70° C., such as greater than about 80° C., such as no greater than about 90° C.

Following impregnation of the wood product, the pressure of treatment chamber is released to atmospheric pressure. Subsequently, an intermediate drying phase is performed. In one example embodiment, the intermediate drying phase may include incubating the impregnated wood product remains immersed in the oil-based preservative in the treatment chamber at atmospheric pressure for about thirty (30) minutes to about one hundred eighty (180) minutes, such as for about 60 minutes to about 120 minutes, or any range therebetween. In another example embodiment, the intermediate drying phase may include at least partially draining the oil-based preservative from the treatment chamber and applying a vacuum within the treatment chamber. During the intermediate drying phase, a gentle vacuum may be initially applied at about negative half (−0.5) bar on the treatment chamber following partial draining of the oil-based preservative for about thirty (30) minutes. After the gentle vacuum, the vacuum pressure may be increased to about negative eighty-five hundredths (−0.85) bar for about thirty (30) minutes to about sixty (60) minutes. Following the intermediate drying phase, the oil-based preservative may be transferred from the treatment chamber to a storage or separation tank. In one example embodiment, the oil-based preservative may be drained from the treatment chamber. It will be understood that two of more steps including incubating the impregnated wood product, the at least partially draining, and the vacuum cycling describe above may be performed during the intermediate drying phase in certain example embodiments.

According to example aspects of the present disclosure, once the oil-based preservative is drained the wood product may be subjected to a final negative pressure treatment. In one example embodiment, a final vacuum applied within the treatment chamber in order to draw excess oil/water/preservative from the wood product impregnated with the oil-based preservative. The pressure applied during the negative pressure treatment may be less than about three (3) bar, such as less than two (2) bar, such as less than one (1) bar. For instance, the pressure applied during the negative pressure treatment may range from −0.1 bar to −1 bar. In one exemplary aspect, the pressure applied during the negative pressure treatment may be about a negative half (−0.5) bar. In another example aspect, the pressure applied during the negative pressure treatment may be about negative eight-tenths (−0.8) bar. Applying negative pressure to the treatment chamber is useful to ensure that the wood product is dripping free and thus can be conveniently transferred from the treatment chamber, if desired. According to the present disclosure, the vacuum is applied within the treatment chamber for no less than thirty (30) minutes to remove water from the wood product impregnated with the oil-based preservative, such as no less than about sixty (60) minutes, such as no less than about one hundred and twenty (120) minutes, such as no less than about one hundred and eighty (180) minutes, such as no less than about two hundred and forty (240) minutes, such as no less than about five (5) hours, such as no less than about twelve (12) hours, such as no less than about twenty-four (24) hours.

Advantageously, methods disclosed herein results in the wood product having a touch-dry, non-bleeding surface immediately after treatment. Surprisingly, methods disclosed herein provide a fast and efficient drying process of an oil-based wood product.

The wood product to be treated in accordance with the present disclosure may include softwoods (e.g., refractory and non-refractory) and hardwoods. For instance, the wood product may include one or more of a utility pole, a fence post, and a railway tie. In one example embodiment, the wood product is a product formed from one or more of pine, spruce, cedar, fir, hemlock, oak, maple, cherry, eucalyptus, poplar, beech, and aspen.

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a”, “an”, and “the” include the plural forms unless the context clearly dictates otherwise. Additionally, the term “includes” means “comprises”. The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about”. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” mean by weight as relative to another component or a percentage of the total weight in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “D50” or “D50 particle size” refers to the volume median particle size, where 50% of the particles of the sample volume have a size below that range or value.

Analogously, as used herein, the term “D95” or “D95 particle size” refers to a value where 95% of the particles of the sample volume have a size below that range or value.

As used herein, the term “particle size” as used herein, unless specifically stated otherwise, refers to the median particle size D50. Particle size can be measured using a laser scattering particle size analyzer, such as a HORIBA LA 910 particle size analyzer.

The terms “median particle size” and “average particle size” and D50 are used herein interchangeably.

As used herein, the term “micronized” as used herein means a median particle size (D50) in the range of 0.01 to 25 microns.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Furthermore, certain aspects of the present disclosure may be better understood according to the following examples, which are intended to be non-limiting and exemplary in nature. Moreover, it will be understood that the compositions described in the examples may be substantially free of any substance not expressly described.

### EXAMPLES

### Example 1

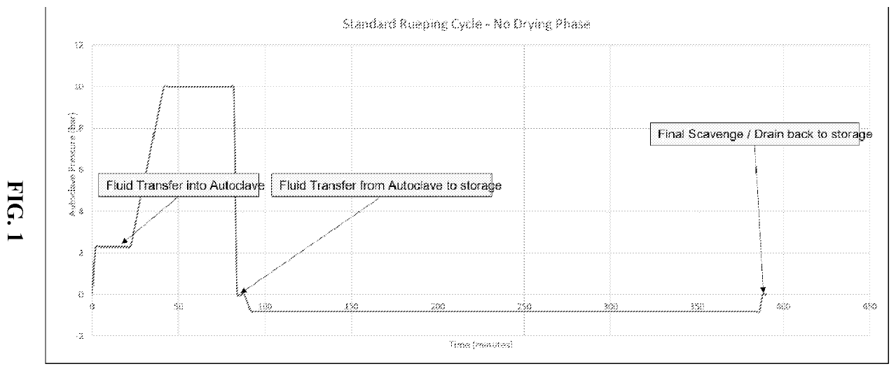

Pine posts were treated using a standard Rueping Process with no ‘drying’ phase (FIG. 1). In Example 1, the oil (namely, Tanasote™) temperature was 60° C. Upon removal, the treated posts had an oily surface residue, with some bleeding from the poles.

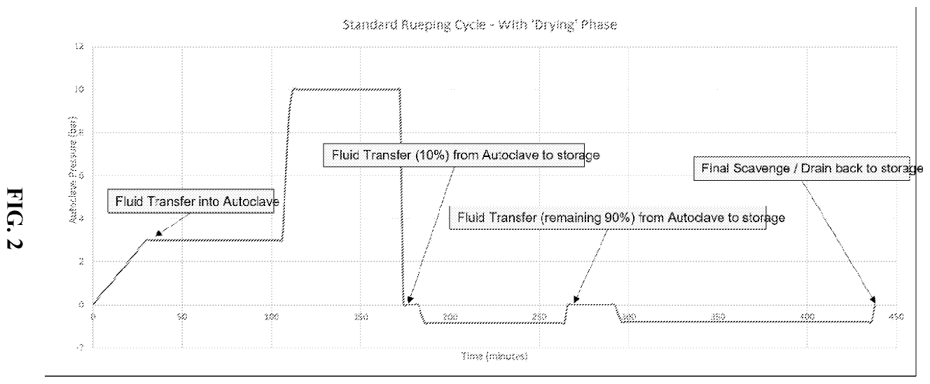

Similar posts were treated using a similar Rueping Process, but with some oil removed from the autoclave, then a vacuum applied as a ‘drying’ phase as described herein prior to draining the bulk of the preservative, and applying a final vacuum. The posts were removed and showed a dry surface appearance with minimal subsequent bleeding (FIG. 2). Posts were dry to the touch and no bleeding was observed after treatment.

### Example 2

A total of 354 incised pine sleepers (12 packs) were treated with Tanasote™ S40 to determine the noise reduction coefficient (NRC) over 3 charges. Treatment cycle for all 3 charges was a Rueping cycle with an intermediate drying phase (iDP) at 65° C., with the cycles process as follows:

TABLE 1
Treatment Cycle for Incised Pine Sleepers.

| Phase | Setpoint (bar) | Time (min) |
|---|---|---|
| Initial air pressure | 3 | 15 |
| Fluid transfer (Fill vessel) | 3 | — |
| Hydraulic pressure | 10 | 30 |
| Partial drain* | — | — |
| Gentle iDP | −0.5 | 30 |
| Full iDP | −0.8 | 60 |
| Fluid Transfer (Empty vessel) | Atmospheric | — |
| Vacuum | −0.8 | 380 |

The treated timber was removed from the treatment chamber touch dry and did not bleed or exude oil during treatment for 2 weeks after treatment.

### Example 3

Four packs of Octowood Pine posts underwent a copper and oil treatment at a large Tanasote plant. Two of the four packs were kiln dried, and the other two packs were air dried. Pieces of all 4 packs underwent various treatments using Bethel, Rueping and modified Rueping cycles.

In this example, a bethel process left the posts dry to touch, but over-treated (e.g., weighing more than double the target retention of preservative) (>200-300 kg/m³). Whereas, a Rueping process resulted in a retention much closer to the target retention (approx. 100 kg/m³) but the posts were wet (e.g., free/residual oil on the surface) when they come out of the treatment vessel and product continued to bleed Tanasote out from the treated timber, for many weeks after treatment, especially when exposed to warmer temperatures (i.e. left in direct sunlight). The bleeding is thought to be due to the initial air pressure put in, expanding as the posts warm and pushing Tanasote out.

Accordingly, the Reuping treated Octowood posts were soaked at atmospheric pressure during the ‘drying phase’ in an expansion bath at 50° C. or 75° C. to reduce bleeding from the surface of the Octowood posts.

Each post was cut into two equal sections (35 cm long) after removing the end grain. One piece from each commodity was submerged in Nytex 801 at 50° C. When the temperature of the oil reached 50° C., pieces were removed after 1, 2 & 3 hours. On removal from the expansion bath, each piece was stood upright for two hours to allow any excess surface oil drain from the timber. They were then patted dry, weighed and photographed. Each bath was repeated in a second set of expansion baths.

TABLE 2
Set 1 of Octowood posts weight gain after expansion bath.

| Pack- | Temp | Time | Start | End | Weight |
|---|---|---|---|---|---|
| Piece | (° C.) | (hours) | Weight (g) | Weight (g) | change (%) |
| 2-126 A | 50 | 1 | 896.72 | 901.59 | 0.54 |
| 2-126 B | 75 | 1 | 891.03 | 890.67 | −0.04 |
| 2-128 A | 50 | 2 | 989.63 | 992.45 | 0.28 |
| 2-128 B | 75 | 2 | 1012.19 | 1009.03 | −0.31 |
| 2-129 A | 50 | 3 | 883.64 | 886.67 | 0.34 |
| 2-129 B | 75 | 3 | 897.48 | 893.37 | −0.46 |
| 4-103 A | 50 | 1 | 1141.84 | 1154.88 | 1.14 |
| 4-103 B | 75 | 1 | 1109.6 | 1095.52 | −1.27 |
| 4-104 A | 50 | 2 | 1079.77 | 1086.26 | 0.60 |
| 4-104 B | 75 | 2 | 1128.19 | 1118.22 | −0.88 |
| 4-105 A | 50 | 3 | 1246.36 | 1250.24 | 0.31 |
| 4-105 B | 75 | 3 | 1191.09 | 1158.78 | −2.71 |

All pieces at 50° C. gained a minor amount of weight regardless of the length of time they were in the expansion bath. Suggesting either there was either a small amount of end grain penetration of Nytex 801, or absorption on the surface of the timber during the expansion bath. Whereas, all pieces exposed to the 75° C. expansion bath had a small decrease in weight overall, suggesting Tanasote™ was released from the timber.

Photos of the posts before and after the expansion bath ‘drying’ phase show that in some instances, the timber was lighter in color, in particular pieces which had been in the 75° C. bath (i.e., 2-129 B, 4-103 B & 4-104 B) (Table 2).

TABLE 3
Set 2 of Octowood posts weight gain after expansion bath.

| Pack - | Temp | Time | Start | End | Weight |
|---|---|---|---|---|---|
| Piece | (° C.) | (hours) | Weight (g) | Weight (g) | change (%) |
| 2-117 A | 50 | 1 | 1023.08 | 1030.35 | 0.71 |
| 2-117 B | 75 | 1 | 1045.78 | 1039.71 | −0.58 |
| 2-118 A | 50 | 2 | 776.61 | 783.6 | 0.90 |
| 2-118 B | 75 | 2 | 778.91 | 775.8 | −0.40 |
| 2-120 A | 50 | 3 | 859.81 | 867.05 | 0.84 |
| 2-120 B | 75 | 3 | 870.94 | 863.12 | −0.90 |
| 3-122 A | 50 | 1 | 1112.56 | 1128.93 | 1.47 |
| 3-122 B | 75 | 1 | 1063.57 | 1045.12 | −1.73 |
| 3-123 A | 50 | 2 | 948.77 | 954.29 | 0.58 |
| 3-123 B | 75 | 2 | 920.67 | 912.54 | −0.88 |
| 3-124 A | 50 | 3 | 875.59 | 882.88 | 0.83 |
| 3-124 B | 75 | 3 | 858.93 | 849.52 | −1.10 |

Very similar results were observed for Set 2 as observed in Set 1. The commodities at 50° C. showed a small increase in mass in comparison to the commodities at 75° C. which showed a small decrease in mass. Again, suggesting raising the temperature above treatment temperature cause some Tanasote to be released from the timber.

Photos of the poses before and after the expansion bath show similar results as set 1, with some looking lighter after the expansion bath (i.e., 3-122 B) (Table 3).

### Example 4

A surface wetness wicking assessment was carried out for each post in Example 3 by placing a piece of white roll on each piece of timber for 72 hours. They were photographed again, prior to being placed outside for continual visual assessment. This was repeated on matched pieces in a second bath, starting at 50° C. and increasing the temperature to 75° C. before the time was started. Note that some air bubbles were observed coming out of the timber as it heated up at both 50° C. and 75° C.

TABLE 4
Wicking Assessment scale.

| Scale | Description |
|---|---|
| 0 | No wicking on white roll |
| 1 | Less than 10% wicking |
| 2 | Less than 30% wicking |
| 3 | Less than 50% wicking |
| 4 | Less than 70% wicking |
| 5 | Over 70% wicking |

TABLE 5
Wicking Assessment of Set 1 in Example 3.

| | Time at | | | |
|---|---|---|---|---|
| Pack - | Temp | | | |
| Piece | (hours) | Control | 50° C. | 75° C. |
| 2-126 | 1 | 4 | 1 | 2 |
| 2-128 | 2 | 3 | 2 | 1 |
| 2-129 | 3 | 5 | 3 | 1 |
| 4-103 | 1 | 1 | 2 | 1 |
| 4-104 | 2 | 2 | 2 | 1 |
| 4-105 | 3 | 1 | 1 | 1 |

All posts which had not been through a drying phase an expansion bath showed much more bleeding on the white roll in comparison to those which had, in particular the ones from pack 2 which had been kiln dried.

Where the control had over 10% wicking, each commodity showed an improvement in the 75° C. expansion bath, regardless of the time, notably in pack 2 which had the worse bleeding at the beginning. Pieces which had been through the 50° C. bath showed an improvement compared to the control in the pieces from pack 2, but similar or worse performance compared to the control in pack 4 (Table 5).

TABLE 6
Wicking Assessment of Set 2 in Example 3.

| | Time at | | | |
|---|---|---|---|---|
| Pack - | Temp | | | |
| Piece | (hours) | Control | 50° C. | 75° C. |
| 2-117 | 1 | 1 | 1 | 1 |
| 2-118 | 2 | 2 | 2 | 1 |
| 2-120 | 3 | 2 | 2 | 1 |
| 3-122 | 1 | 1 | 1 | 1 |
| 3-123 | 2 | 2 | 3 | 1 |
| 3-124 | 3 | 3 | 1 | 1 |

For Set 2, the wicking assessment was compared to the off cuts of each commodity, as larger pieces were not available for individual assessment. Limited pieces of timber were available to choose from which had all been through the same treatment process, had not been through an expansion bath, had been treated recently and were bleeding. All pieces chosen looked wet and saturated with Tanasote when they were chosen.

The control pieces for set 2 showed much less wicking than set 1 (Table 6). The 75° C. expansion bath showed an improvement or similar performance (where the control has less than 10% wicking) in the wicking assessment in each commodity compared to the control. The 50° C. bath showed similar performance compared to the control for pieces from pack 2 and a range of results for the pieces in pack 3 (Table 6).

In both sets of expansions baths the pieces of timber at 50° C. increased in weight which is thought to be due to end grain penetration. All pieces at 75° C. decreased slightly in weight overall, suggesting Tanasote was released from the timber.

Some pieces exposed to the 75° C. bath were visually lighter in color after the expansion bath compared to the start, most notably pieces 2-129 B, 4-103 B, 4-104 B & 3-122 B.

In Set 1, for each commodity where the control had over 10% wicking on the white roll, there was an improvement in the 75° C. bath, most notably in pack 2 which showed more bleeding originally. For commodities where the control had less than 10% wicking in the control, the performance of the pieces in the 75° C. bath remained the same. The 50° C. bath showed an improvement for the pieces from pack 2, thought to be kiln dried, but similar or worse performance for pack 4, believed to be air dried.

The wicking assessment of set 2 had similar results. Where the control had more than 10% wicking, each commodity at 75° C. improved in the wicking assessment, regardless of time. The 50° C. bath had no improvement in the wicking assessment compared to the control, 5 out of 6 pieces remained the same, with one performing worse.

Overall, both sets of expansion baths showed an improvement at 75° C. compared to the controls, at 1, 2 & 3 hours. The 50° C. expansion bath shows some improvement for some commodities, but not the consistently for all pieces from each pack or for a specific length of time. Based on these data, it is recommended to use an expansion bath at 75° C. instead of 50° C.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A method for treating a wood product, comprising:
injecting an oil-based preservative into a treatment chamber with the wood product;
pressurizing the treatment chamber with the wood product and the oil-based preservative in order to impregnate the wood product with the oil-based preservative, wherein the pressure of the treatment chamber is from about 0.5 bar to about 12 bar;
releasing the pressure of the treatment chamber to atmospheric pressure;
performing an intermediate drying phase comprising one or more of incubating the impregnated wood product with the oil-based preservative at a temperature of no greater than ninety degrees Celsius,
at least partially draining the oil-based preservative from the treatment chamber,
and/or
applying a vacuum within the treatment chamber;
after performing the intermediate drying phase, draining the oil-based preservative from the treatment chamber; and
applying a vacuum in a drying phase within the treatment chamber in order to remove excess preservative from a surface of the impregnated wood product.

2. The method of claim 1, wherein from about 5% to about 30% of the oil-based preservative is drained from the treatment chamber during the intermediate drying phase.

3. The method of claim 1, wherein the wood product comprises one or more of a utility pole, a fence post, and a railway tie.

4. The method of claim 1, wherein the wood product comprises a product formed from one or more of pine, spruce, cedar, fir, hemlock, oak, maple, cherry, eucalyptus, poplar, beech, and aspen.

5. The method of claim 1, wherein the temperature of the oil-based preservative is no less than forty degrees Celsius when the wood product is impregnated with the oil-based preservative.

6. The method of claim 1, wherein the temperature of the oil-based preservative is about sixty degrees Celsius when the wood product is impregnated with the oil-based preservative.

7. The method of claim 1, wherein a vacuum of no greater than a half bar is applied during the drying phase to remove excess preservative from the surface of the impregnated wood product.

8. The method of claim 1, wherein the treatment chamber is pressurized for no less than five minutes and no greater than three hundred minutes to impregnate the wood product with the oil-based preservative.

9. The method of claim 1, wherein, after the oil-based preservative has been drained from the treatment chamber, the vacuum is applied within treatment chamber for no less than thirty minutes to remove excess preservative from the surface of the impregnated wood product.

10. The method of claim 1, further comprising removing the wood product impregnated with the oil-based preservative from the treatment chamber, a temperature of wood product impregnated with the oil-based preservative from the treatment chamber being no greater than sixty degrees Celsius when the wood product impregnated with the oil-based preservative is removed from the treatment chamber.

11. The method of claim 1, wherein the oil-based preservative comprises copper and at least one organic co-biocide agent.

12. The method of claim 10, wherein the copper is present within the oil-based preservative at no less than about 1% by weight of the oil-based preservative and no greater than about 10% by weight of the oil-based preservative.

13. The method of claim 10, wherein the at least one organic co-biocide agent is present at no less than about 0.01% by weight of the oil-based preservative and no greater than about 10% by weight of the oil-based preservative.

14. The method of claim 10, wherein the at least one organic co-biocide agent comprises one or more of an isothiazolone, a pyrethroid, a neonicotinoid, a halogenated carbamate, a quaternary ammonium salt, succinate dehydrogenase inhibitor (SDHI) and an azole.

15. The method of claim 1, wherein the impregnated wood product is incubated with the oil-based preservative for no more than one-hundred eighty minutes during the intermediate drying phase.

16. The method of claim 1, wherein the impregnated wood product is incubated with the oil-based preservative for no more than sixty minutes during the intermediate drying phase.

17. The method of claim 1, further comprising applying a second vacuum after the removal excess preservative from the surface of the impregnated wood product.

18. A wood product treated according to the method of claim 1.
